(19) United States
(12) Patent Application Publication
(10) Pub. No.: US 2026/0270319 A1
(43) Pub. Date: Sep. 10, 2026

(54) METHODS, ARCHITECTURES, APPARATUSES AND SYSTEMS FOR RELOCATING SERVER OF A CONSUMER NODE IN A BREAK-BEFORE-MAKE PATTERN

(71) Applicant: InterDigital Patent Holdings, Inc., Wilmington, DE (US)

(72) Inventors: Michel Roy, Candiac (CA); Kevin Di Lallo, Laval (CA); Taimoor Abbas, Sainte-Julie (CA); Michael Starsinic, Newtown, PA (US)

(21) Appl. No.: 19/473,216

(22) PCT Filed: Apr. 5, 2024
(86) PCT No.: PCT/US2024/023291

§ 371 Date: Oct. 7, 2025

Related U.S. Application Data
(60) Provisional application No. 63/457,821, filed on Apr. 7, 2023.

(51) Int. Cl. H04L 67/148

(52) U.S. Cl. CPC H04L 67/148

(57) ABSTRACT

In an embodiment, a method implemented in a wireless transmit/receive unit, WTRU, comprises receiving a server set configuration associated with an active server; detecting unavailability of the active server; selecting an alternate server based on the received server set configuration; transmitting, to the alternate server, a server switch request message, wherein the server switch request message includes a WTRU identifier; receiving, from the alternate server, a switch response message, wherein the switch response message includes procedures for communicating to the alternate server; and communicating to the alternate server based on the procedures.

### CROSS-REFERENCE TO RELATED APPLICATIONS

The present application claims the benefit of U.S. Provisional Patent Application No. 63/457,821 filed Apr. 7, 2023, which is incorporated herein by reference.

### FIELD OF THE INVENTION

The present disclosure is generally directed to the fields of communications, software and encoding, including, for example, to methods, architectures, apparatuses, systems directed to reliable edge enablement layer.

### BACKGROUND

A core functionality offered by an edge enablement layer (EEL) may allow a wireless transmit/receive unit, WTRU, to be provisioned with edge connectivity information, to discover available edge services, and to maintain edge service while moving through the mobile network.

A high-reliability edge enablement layer may be possible by using edge configuration server (ECS) and/or edge enabler server (EES) sets. A server set may be composed of pre-defined alternative servers for replacing an active ECS and/or active EES that may be used by a WTRU, an edge enabler client (EEC), an edge application server (EAS), or EES. The EEL of a 5G system does not provide support for server sets.

Current 5G system does not support mechanism for providing reliable edge computing.

There is a need to introduce new functionality in the edge enablement layer of the 5G system so that the EEL may use server sets to manage and make edge network behavior predictable in case of failure.

### SUMMARY

In an embodiment, a method implemented in a wireless transmit/receive unit (WTRU) may comprise a step of receiving a server set configuration associated with an active server. The method may comprise a step of detecting/determining unavailability of the active server. The method may comprise a step of determining/detecting unavailability of the active server may be based on a timeout failure of communication with the active server. The method may comprise a step of selecting an alternate server based on the received server set configuration. The method may comprise a step of transmitting, to the alternate server, a server switch request message, wherein the server switch request message may comprise first information indicating an identifier of the WTRU. the method may comprise a step of receiving, from the alternate server, a server switch response message, wherein the server switch response message may include procedures information for communicating to the alternate server and resource mapping information related to the alternate server. The procedures information may comprise procedures for confirming server switch successful, wherein the procedures for confirming server switch successful may comprise a registration updated procedure with the alternate server. Resource mapping information may include uniform resource identifiers (URIs) or identifiers corresponding to resources at the active server. The method may comprise a step of mapping bindings based on received resource mapping information; and a step of transmitting communicating to the alternate server using the received procedures information.

In another embodiment, a method, implemented in a server, may comprise a step of receiving a server switch request message from a wireless transmit/receive unit (WTRU) wherein the server switch request message may comprise a WTRU identifier. The method may comprise a step of determining resource mapping (e.g., identifying passive and active resources mapping) associated with the WTRU based on the WTRU identifier. The method may comprise a step of transmitting, to the WTRU, a server switch response message, wherein the server switch response message may include procedures information for communicating to the server and the determined resource mapping. The method may comprise a step of receiving communication from the WTRU based on the provided/transmitted procedures information.

In another embodiment, a method implemented in a wireless transmit/receive unit, WTRU, may comprise: receiving a server set configuration associated with an active server; receiving a server switch notification message from an active server, wherein the server switch notification message comprising information indicating an alternate server, procedures for communicating with the alternate server, and timing information indicating when to access the alternate server; establishing connectivity with an edge data network of the alternate server; and communicating with the alternate server based on the procedures.

In another embodiment, a method implemented in a server, may comprise: selecting an alternate server for transferring resources; transmitting a first server switch notification message to a WTRU, wherein the first server switch notification message comprises information indicating the alternate server; transmitting a server switch request message to the alternate server, wherein the server switch request message includes passive and active resources of the active server associated with the WTRU; receiving a server switch response message from the alternate server, wherein the server switch response message includes mappings of active server resources associated with the alternate server; and transmitting a second server switch notification to the WTRU associated with the resources transferred to the alternate server.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of an architecture diagram for enabling edge applications;

FIG. 3 is examples of a message sequence chart of an edge system;

FIG. 4 is an example of a message sequence chart of an edge enabler server switch in a first break-before-make scenario;

FIG. 5 is an example of a message sequence chart of an edge configuration server switch in a second break-before-make scenario;

FIG. 6 is an example of a message sequence chart of an edge enabler server switch in a first make-before-break scenario;

FIG. 7 is an example of a message sequence chart of an edge configuration server switch in a second make-before-break scenario;

FIG. 8 is a flow chart illustrating an example of a method, performed by a consumer node for relocating a server in a break-before-make manner;

FIG. 9 is a flow chart illustrating an example of a method performed by an alternate server for relocating an active server;

FIG. 10 is a flow chart illustrating an example of a method, performed by a consumer node for relocating a server in a make-before-break manner;

FIG. 11 is a flow chart illustrating an example of a method performed by an active server for relocating the active server in a make-before-break manner.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

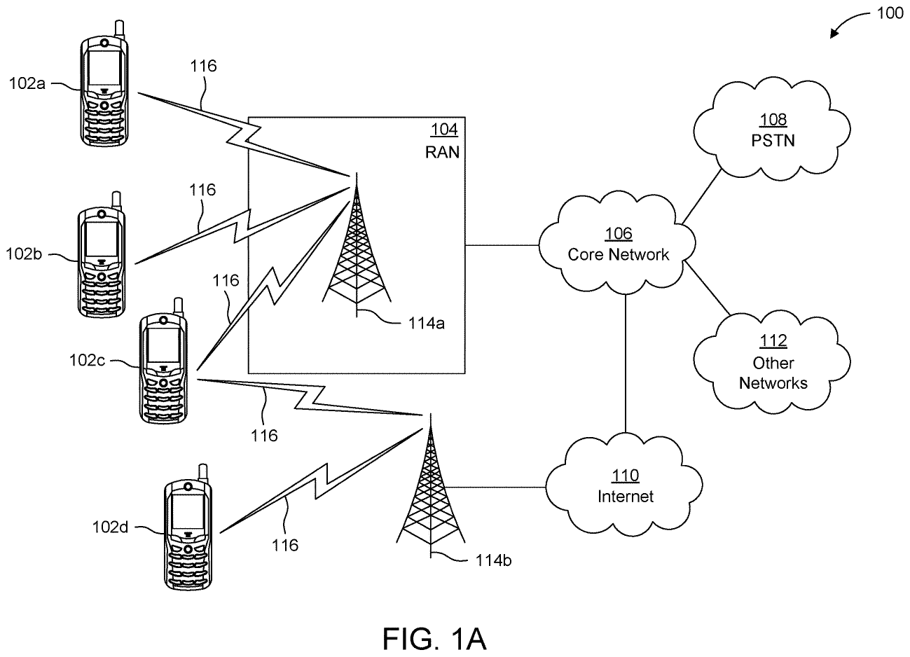

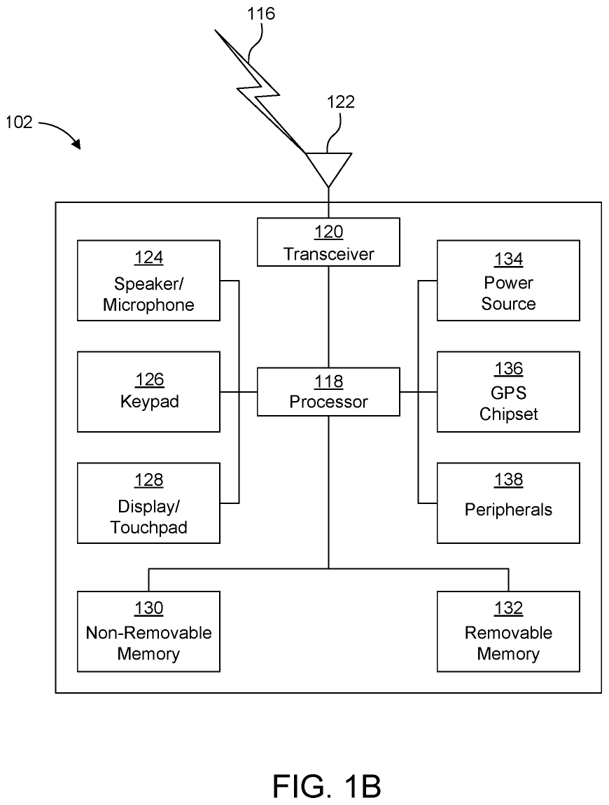

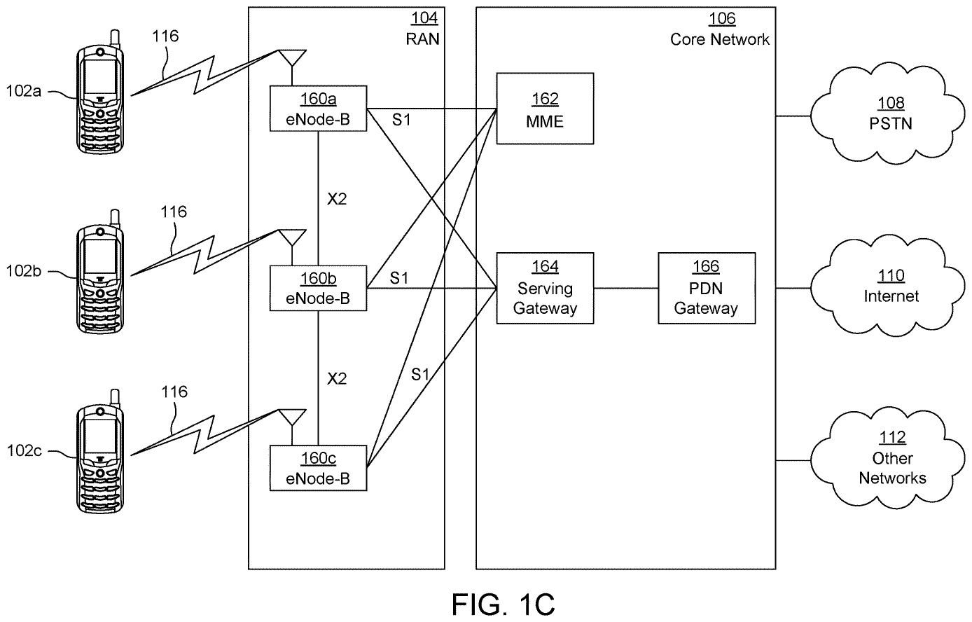

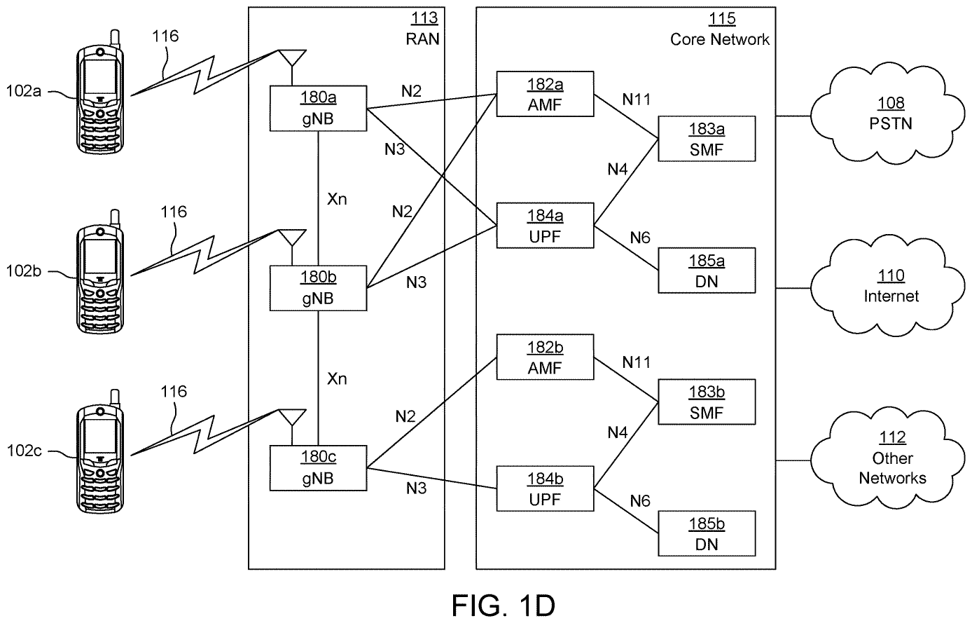

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

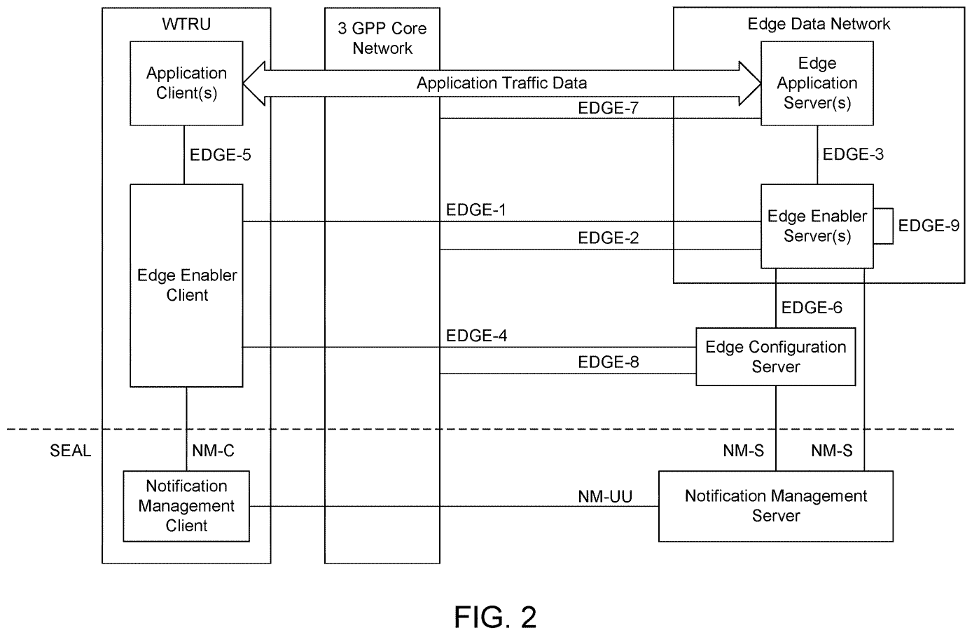

Referring to FIG. 2, an architecture for enabling edge applications is shown. Accordingly, SA6 architecture is defined in document “3GPP TS 23.558 V 18.1.0 (2022-12) “Architecture for enabling Edge Applications”. The high-level architecture for enabling edge applications presented on FIG. 2 depicts an edge enablement layer, EEL, that may allow applications on a wireless transmit/receive unit, WTRU, to consume edge services from a mobile network. The core functionality offered by the EEL may allow a WTRU to be provisioned with edge connectivity information, to discover available edge services, and to maintain edge service while moving through the mobile network. The main components of the SA6 architecture are described below.

An application client, AC, is a user application residing on a WTRU that communicates with an EAS. A WTRU may use several AC concurrently.

An edge application server, EAS, is an application server resident in an edge data network, EDN. It may be a software server executing on generic hardware located at the edge and providing a service to the AC. In the context of a mobility/relocation use case, the source-EAS, S-EAS, is an instance of an EAS in an initial location and serving the AC before mobility/relocation happens, and the target-EAS, T-EAS, is an instance of an EAS in a destination location and serving the AC after mobility/relocation has happened. There may be multiple EAS instances per EDN. Each EDN may contain a different set of EAS instances of different types; an EAS may serve one or more AC instances that may reside on different WTRUs.

An edge enabler client, EEC, may provide edge support to the AC instances on the WTRU. There may be one or more EEC per WTRU. Each AC may use only one EEC.

An edge enabler server, EES, may provide supporting functions needed by EAS and EEC. In the context of a mobility/relocation use case, the source-EES, S-EES, is the EES used before mobility/relocation happens, and the Target-EES, T-EES, is the EES used after mobility/relocation has happened. There may be one or more EES instance per EDN, or per data network name, DNN. There may be multiple EDN instances in the network.

An edge configuration server, ECS, may provide supporting functions for an EEC or EES to discover EES instances providing certain EAS. There may be one or more ECS for the network.

A notification management client, NMC, may provide supporting functions for an EEC to create a notification channel between the NMC and the NMS to receive notifications from the ECS or EES. Each EEC uses only one NMC.

A notification management server, NMS, may provide supporting functions for an ECS or EES to send notifications to an EEC via a notification channel created between the NMC and the NMS. There can be one or more NMS for the network.

The main passive and active resources of the SA6 architecture are described below.

A passive resource may represent information stored on a server; a passive resource may mainly consume storage (e.g., memory, disk space) resource of the server. The information associated with the passive resource may be used internally by the server, may be accessible externally through an application programming interface, API, server, may change over a period of time, may be information related to internal states of the server or may be information related to external clients of the server.

An active resource may represent actions performed on a server. An active resource may (e.g., mainly) consume processing and/or networking resources of the server. The actions associated with the active resource may be triggered by internal server operations, may be triggered by interaction with an external client through an API, may vary over a period of time, may require temporary execution and communication, may require constant or periodic execution and communication.

Passive resources in the EES may include the EEC context created when an EEC registers to an EES, the EAS profile created when an EAS registers to an EES, the various subscriptions created when EES clients (e.g., EEC, EAS, EES) subscribe to EES event notifications.

Active resources in the EES may include the event detection related to subscriptions created by EES clients (e.g., EEC, EAS, EES), the application context relocation (ACR) event detection and processing that is initiated at the EES and related to an application client (AC) communicating with an EAS, the 5GS periodic events (ex. WTRU location) that may be requested from the 5GS by the EES.

Passive resources in the ECS may include the EES profile created when an EES registers to an ECS, the various subscriptions created when ECS clients (e.g., EEC, EES, ECS) subscribe to ECS event notifications.

Active resources in the ECS may include the event detection related to subscriptions created by ECS clients (e.g., EEC, EES, ECS), the 5GS periodic events (ex. UE location) that may be requested from the 5GS by the ECS.

In order to enable support of server sets in the EEL, solutions are desired for the following aspects: The content of ECS/EES server set information and how it should be provisioned or managed and distributed throughout the EEL. The actions that should be triggered at an active ECS or at an active EES and at their related consumers nodes to support server switching in planned and unplanned service unavailability use cases.

Terminology applicable to the below description is defined herein:

An active server is a server instance (e.g., EES or ECS) associated with a server set. The active-server instance may be used by a consumer node.

An alternate server is a server instance (e.g., EES or ECS) associated with a server set. The alternate-server instance may be not used by a consumer node and may be considered as a replacement server instance for an active-server.

A consumer node is a node instance (e.g., WTRU, EEC, EAS, EES) that may consume services from an active server instance associated with a server set.

A server set management function, SSMF, is a network function residing on a network node. An SSMF may provide functionality for managing server set configuration, generating server set events and switching from an active server to an alternate server. SSMF may be implemented in an active server, such as EES or ECS, or may also be implemented in an independent network node.

An SSMF client describes client-side functionality residing on a node consuming services from an active server (e.g., EES, ECS) associated with a server set; SSMF client may be implemented in a consumer node, such as WTRU, EEC, EAS or EES consuming services from an active server.

SSMF client and consumer node may be used interchangeably herein.

Below is a description of examples of server set provisioning and management.

Server set configuration data is needed for maintaining the association between server instances included in a server set. Server set configuration data may include identifiers of server instances included in the server set and an indication of the server set type (e.g., for ECS, for EES).

For example, an EES server set may include an indication that the server set type is for EESs and the EES identifiers, EESIDs, identifying EES instances of the server set.

For example, an ECS server set may include an indication that the server set is for ECSs and ECSs configuration information (e.g., an IP, URI, FQDN, and/or PLMN) identifying ECS instances of the server set.

Server(s) set configuration data may be enhanced with additional information to facilitate usage or limit the scope of a server set. Additional configuration data may include active server identifier(s) (e.g., EESID or ECS IP or ECS URI or ECS FQDN or PLMN) which identifies active server(s) to which the server set is applicable, connectivity information (e.g., DNN/APN, S-NSSAI) for each server instance of the server set which identifies how to establish connectivity to servers of the server set, EES endpoint information (e.g., EES IP or EES URI or EES FQDN) which identifies the endpoint information associated with each EESID. The Additional configuration data may further include edge computing service provider, ECSP, information (e.g., ECSP identifier) associated with the server set or with each server of the server set indicating a validity condition based on ECSP, service area information (e.g., topological, geographical) associated with the server set or associated with each server instance of the server set indicating a validity condition based on geography or network topology, time period associated with the server set or with each server of the server set indicating a validity condition based on time, server priority information associated with each server of the server set indicating in the priority order in which the servers are to be considered on an active server failure.

Server set configuration data may be obtained by a consumer node following different scenarios. Server set configuration data may be pre-provisioned on a consumer node, or may be provisioned to a consumer node when configuring the consumer node or may be provisioned to a consumer node when detecting an event in real time or predicting an anticipatory event that requires an active server to be replaced with an alternate server.

In any scenarios, the consumer node may be informed or be aware of that a server set is used to ensure that consumer node behavior is compliant with server set usage. The consumer node may be informed of server set usage via a static setting at the consumer node indicating that server sets are always/never used, or via receiving a server set configuration indication that server sets are used for all or a subset of the ECS/EES servers, or implicitly by receiving server set configuration data.

For the scenarios where the consumer node obtains the server set configuration data from a different source than the active server (e.g., pre-configured or configured by an external source), the consumer node may need to indicate to the active server that a server set is used to ensure that active server behavior is compliant with server set usage. The active server may be informed of server set usage via a static setting at the active server indicating that server sets are always/never used, or via receiving a server set configuration indication from the consumer node that server sets are used for all or a subset of the ECS/EES servers, or implicitly by receiving server set configuration data or a subscription for server set events.

For a WTRU (e.g., EEC) as a consumer node of an ECS, the ECS server set configuration data may be pre-configured with the WTRU or EEC, or may be configured by an edge-aware application client, AC, or may be configured by a user, or may be provisioned by a mobile network operator, MNO, through 5GC procedure if the MNO has the capability to deliver ECS server set configuration data to the WTRU and the WTRU has the capability to deliver ECS server set configuration data to the EEC on the WTRU. Additionally, ECS server set configuration data may be provided to the WTRU or EEC through a service provisioning procedure with an ECS (including request/response or subscription/notification mechanisms), or may be provided through a dedicated procedure with the ECS, or may be provided through a notification event when the active server is replaced with an alternate server.

For a WTRU (e.g., EEC) as a consumer node of an EES, the EES server set configuration data may be pre-configured with the WTRU or EEC, or may be configured by an edge-aware AC, or may be configured by a user. Additionally, EES server set configuration data may be provided to the WTRU or EEC through an EEC registration procedure with an EES, or may be provided to the WTRU or EEC through an EAS discovery procedure with an EES (e.g., including request/response or subscription/notification mechanisms), or may be provided through a dedicated procedure with the EES, or may be provided through a notification event when the active server is replaced with an alternate server.

For the EAS as a consumer node of an EES, the EES server set configuration data may be pre-configured with the EAS, or may be provided to the EAS through an EAS registration procedure with an EES, or may be provided through a dedicated procedure with the EES, or may be provided through a notification event when the active server is replaced with an alternate server.

For the EES as a consumer node of an ECS, the ECS server set configuration data may be pre-configured with the EES, or may be provided to the EES through an EES registration procedure with an ECS, or may be provided through a dedicated procedure with the ECS, or may be provided through a notification event when the active server is replaced with an alternate server.

Upon obtaining a server set configuration data, the consumer node may validate the server set configuration to verify if it is associated with at least one server used by the consumer node, may store the server set configuration data and may associate it with one or more active server(s), may retrieve connectivity data (e.g., service provisioning procedure) based on alternate server(s) and validity conditions present in the server set configuration, may establish connectivity to EDNs associated with the alternate server(s).

A consumer node may indicate a capability for supporting server sets to a server implementing the SSMF. The SSMF may take the consumer node capability into consideration to determine if server set configuration should be provided to the consumer node.

The capability may be provided by the consumer node to the SSMF as part of procedures mentioned above. For example, when the consumer node is a WTRU (e.g., EEC), the consumer node capability may be provided to an ECS implementing SSMF when the WTRU performs the service provisioning procedure, the consumer node capability may be provided to an EES implementing SSMF when the WTRU performs the EEC registration, EAS discovery or EAS information provisioning procedures. For example, when the consumer node is an EAS, the consumer node capability may be provided to an EES implementing SSMF when the EAS performs EAS registration. For example, when the consumer node is an EES, the consumer node capability may be provided to an ECS implementing SSMF when the EES performs EAS registration.

The capability may be implicitly provided by the consumer node to the SSMF as part of the subscription to server set events.

The consumer node may be notified of server set events when an active server needs to be relocated to an alternate server or when server set configuration data changes. For example, if a SSMF is configured to shutdown, it may send a server set event to the consumer nodes to indicate its future unavailability. For example, if the SSMF is subscribed to a network data analytics function, NWDAF, in a 5G system, the SSMF may be informed that the connectivity to the SSMF is down or expected to be down and send server set events to the consumer nodes accordingly.

To receive notifications related to server set events, the consumer node may subscribe with the network node implementing the SSMF and may maintain a valid subscription (e.g., subscription must not expire).

In certain implementation, the subscription may associate with an expiration time, and the consumer node may need to renew its subscription to prolong its validity.

A consumer node may be notified of a server set event when an active server needs to be replaced by an alternate server (e.g., a server switch notification). The server switch notification sent to the consumer node may include information about the alternate server selection, may include any service set configuration information, may include an indication that registration at the alternate server is needed, may include timing information indicating when the alternate server will be ready (e.g., when the transition of the active server towards the alternate server will be completed), and may include subscription identifier information if the consumer subscription identifiers at the active server changed once transitioned at the alternate server.

Upon receiving a server switch notification, the consumer node may validate the notification to verify if the it is associated with a server used by the consumer node, may perform alternate server selection based on the server set configuration if the alternate server is not indicated in the notification, may retrieve connectivity information about the selected alternate server, may establish connectivity (e.g., PDU session with the EDN) to the alternate server, may register to the alternate server, may store and use any server set configuration information provided in the notification for identifying and accessing the alternate server, may replace any bindings to the active server with bindings to the alternate server, may set a timer based on provided timing information to delay access to the alternate server, may update existing subscription identifiers obtained from the active server with newly provided subscription identifiers valid at the alternate server.

As a result of the server switch notification received and processed at the consumer node, it can be observed that the consumer node may interact with the alternate server.

A consumer node may be notified of a server set event when the server set configuration changes (e.g., a server set configuration update), for example if an alternate server suddenly becomes unavailable, it may be removed from the server set or may be replaced by another alternate server. The notification sent to the consumer node may include any service set configuration information or may indicate that the server set is not used anymore.

Upon receiving the server set configuration update notification, the consumer node may validate the notification to verify if the request is associated with a server used by the consumer node, may trigger request to SSMF for new server set configurations, may store and update its server set configuration according to the received server set configuration information, may perform any processing related to receiving a server set configuration.

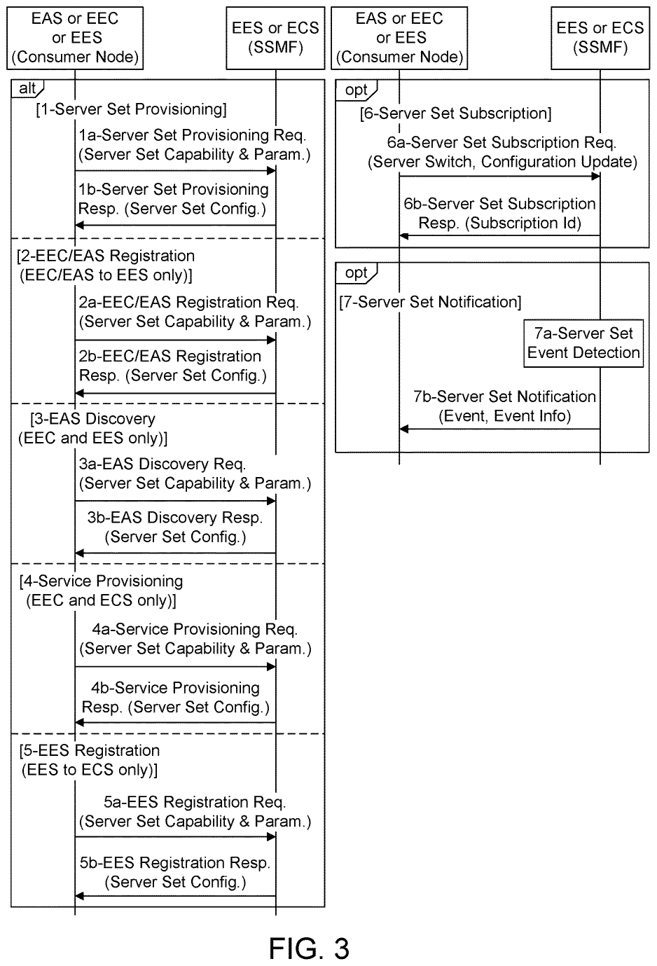

At FIG. 3, examples of a message sequence chart of an edge system are shown. Referring to FIG. 3, an edge system where the SSMF may be an EES or ECS and where the consumer node may be an EAS or EEC is shown. Alternative embodiments for provisioning the server set configuration to the consumer node are shown. Multiple server set provisioning embodiments may happen in the same system, for example an ECS may provide ECS server set information to the EEC in the service provisioning procedure and an EES may provide EES server set information to the EEC and EAS in the EEC/EAS registrations procedures.

Referring to 1, in an embodiment, a consumer node may send a server set provisioning request (1a) to a SSMF (e.g., EES, ECS) to obtain the server set configuration. The provisioning request may indicate to the SSMF the server set capability that the consumer node may support the server set functionality and may contain server set parameters which may include active server identifier(s) (e.g., EES and/or ECS identifiers) indicating for which server(s) the configuration is applicable. The provisioning request may further include ECSP identifier(s) indicating ECSP(s) for which the configuration is requested. The provisioning request may further include a service area (e.g., topological or geographical) indicating the service area for which the configuration is requested, and may include a time period indicating the time for which the configuration should be valid.

After receiving and processing the request, the SSMF may identify or may create a server set configuration that meets the requirements for given server set parameters provided in the request and may send a server set configuration response including the server set configuration to the consumer node. If the SSMF is not able to provide a server set configuration, the SSMF may provide an error code and a reason of not providing a server set configuration.

Upon receiving the server set provisioning response, the consumer node may perform server set configuration processing.

Referring to 2, in an embodiment, a registration procedure may be performed when the consumer node is an EEC (e.g., UE) or EAS and the SSMF is an EES. The EEC registration procedure or EAS registration procedure may be enhanced to provide respectively the EEC or EAS server set capability to the EES in the request message and to provide server set configuration respectively to the EEC or EAS in the response message. The EEC may send an EEC registration request (2a) or the EAS may send an EAS registration request (2a) to the EES and the request may include an indication that the EEC or EAS supports server sets functionality and may include server set parameters.

After receiving and processing the request, the SSMF may provide a server set configuration that meets the server set parameters provided in the request and returns it to the EEC/EAS in the EEC/EAS registration response (2b). If the SSMF is not able to provide a server set, it may indicate it to the EEC/EAS in the EEC/EAS registration response. The EEC/EAS registration response may include a failure cause and reason.

Referring to 3, in an embodiment, the registration procedure may be performed when the consumer node is an EEC (e.g., WTRU) and the SSMF is an EES. The EAS discovery procedure may be enhanced to provide the EEC server set capability to the EES in the request message and to provide server set configuration to the EEC in the response message. The EEC may send an EAS discovery request (3a) to the EES and may include an indication that the EEC supports server sets functionality and may include server set parameters.

After receiving and processing the request, the SSMF provides a server set configuration that meets the server set parameters provided in the request and returns it to the EEC in the EAS discovery response (3b). If the SSMF is not able to provide a server set, it may indicate so in the EAS discovery response. The EAS discovery response may include a failure cause and reason.

Referring to 4, in an embodiment, a service provisioning procedure may be performed when the consumer node is an EEC (e.g., WTRU) and the SSMF is an ECS. The service provisioning procedure may be enhanced to provide the EEC server set capability to the ECS in the request message and to provide server set configuration to the EEC in the response message. The EEC may send a service provisioning request (4a) to the ECS and may include an indication that the EEC supports server sets functionality and may include server set parameters.

After receiving and processing the request, the SSMF provides a server set configuration that meets the server set parameters provided in the request and returns it to the EEC in the service provisioning response (4b). If the SSMF is not able to provide a server set, it may indicate so in the service provisioning response.

Referring to 5, the procedure may be performed when the consumer node is an EES and the SSMF is an ECS. The EES registration procedure may be enhanced to provide the EES server set capability to the ECS in the request message and to provide server set configuration to the EES in the response message. The EES may send an EES registration request (5a) to the ECS and the request may include an indication that the EES supports server sets functionality and may include server set parameters.

After receiving and processing the request, the SSMF may provide a server set configuration that meets the server set parameters provided in the request and returns it to the EES in the EES registration response. If the SSMF is not able to provide a server set, it may indicate it to the EES in the EES registration response, the response may include a failure cause and reason.

Referring to 6, in an embodiment, the consumer node may send a server set subscription (6a) to the SSMF to receive notifications related to server set events that may be detected in the network. The subscription request may include an indication for events related to server switch, may include an indication for receiving events related to server set configuration update.

After receiving and processing the request, the SSMF may include a subscription identifier in the server set subscription response (6b) and may initiate detection of the server set subscribed events. If the SSMF is not able to allocate resources or perform server set event detection, the SSMF may indicate a failure in the server set subscription/registration response and may include a reason.

Referring to 7, in an embodiment, upon detection of a server set event (7a), the SSMF may send a server set notification (7b) to the consumer node on the condition that a consumer node has subscribed for that event, indicating the detected event and providing additional information. Upon reception of the server set notification, the consumer node may perform processing of the event.

For all the procedures mentioned in this clause, upon failure indication, the consumer node may retry considering the failure cause, otherwise the consumer node may wait for a certain period before making another attempt. For example, the consumer node may start a timer associated to failure cause code and only after the timer is expired the consumer node may make another attempt to send server set subscription request.

In the below description, details on “break-before-make”, BBM, procedure is detailed.

In various embodiments, the replacement of an EES active server may be unplanned. For example, an active server may lose power or connectivity and become unreachable. Server switch may be performed in a “break-before-make”, BBM, manner, allowing consumer nodes (e.g., EAS, EEC) migration to an alternate EES server after the active server becomes unavailable.

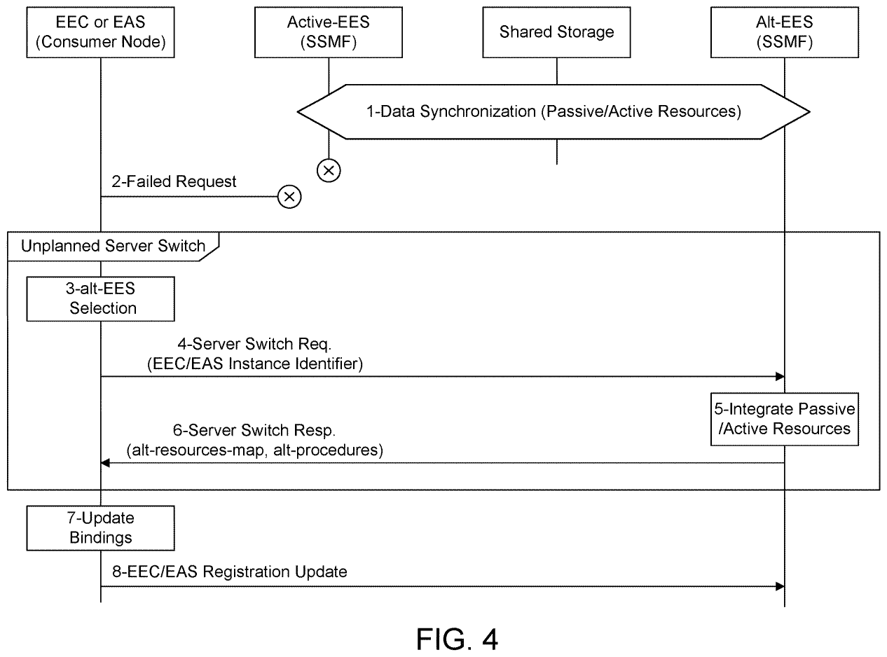

FIG. 4 shows an example of a procedure for consumer nodes, active EES and alternate EES re-configuration in a “break-before-make” scenario.

Prior to BBM procedure, the consumer nodes (e.g., EEC, EAS) may have discovered the active EES, may have been configured with an EES server set, and may have subscribed to EES server set events.

To support break-before-make, BBM, server switch using a server set, a synchronization methodology may be pre-established between servers of the server set. The synchronization methodology may be centralized and based on a shared storage. Servers of the server set may continuously publish information about their passive and active resources to a shared storage to make resource information available to other servers of the server set in case of unexpected unavailability.

Alternatively, the synchronization methodology may be distributed and based on a messaging scheme. Servers of the server set may continuously send information about their passive and active resources by sending messages to every other server of the server set. Regardless of the synchronization mechanism, the information provided by an active server (e.g., centralized or distributed) remains inactive at the alternate servers until an alternate server is informed that a server switch is required.

Referring to 1, the active EES, active-EES, and the alternate EESs, alt-EES, member of the same EES server set, may publish data about the passive and active resources in a centralized or distributed manner.

Referring to 2, the consumer node (e.g., EEC or EAS) may perform a request with the active EES and the request may fail indicating that the active EES is unexpectedly unavailable. For example, a consumer node may consider that a request timeout failure indicates that a server is unavailable while a “forbidden” response indicates another issue. Alternatively, the consumer node(s) may implement a watchdog mechanism to allow to detecting active server unavailability in a consistent manner. For example, the consumer node may send a keepalive request to the active server on a periodic basis to perform a timely detection of unavailability.

Referring to 3, the consumer node may perform a selection of an alternate EES based on the server set configuration that was provisioned. The selection may be based on KPIs that are similar to those of the active EES or may be based on other validity conditions such as any of ECSP, service area, time, and alternate server priority.

Referring to 4, the consumer node may send a server switch request to the selected alternate EES, providing in the server switch request an EEC or EAS instance identifier. The EEC or EAS identifier may be used by the alternate EES to identify passive and active resources associated with the consumer node. Data about the passive and active resources may be available in a shared storage or at the alternate EES, dependent on a centralized or distributed synchronization mechanism is used.

Referring to 5, upon receiving the server switch request from the consumer node, the alternate EES may integrate the active EES passive and active resources associated with the consumer node and may identify using the EEC or EAS instance identifier. Integrating received resources may require any of: (1) storing the data related to the identified resources in the alternate EES, (2) validating that the identified resources are compatible with the alternate EES capabilities, (3) regenerating resource identifiers or uniform resource identifiers, URIs, at the alternate EES for the identified resources, (4) initiating event detection at the alternate EES for the subscription resources, (5) initiating ACR detections at the alternate EES, and (6) requesting periodic events from the 5GS at the alternate EES.

Referring to 6, upon completing integration of the passive and active resources identified using the server switch request, the alternate EES may send a server switch response to the consumer node which may indicate that the resource integration is completed. The server switch response may further contain resource mapping information related to newly integrated resources at the alternate EES and how these integrated resources map to the resources originally found at the active EES. The server switch response may further contain indication of required procedures with the alternate EES which may indicate to the alternate EES that the server switch completed successfully at the consumer node. For example, resource mapping information may include newly generated URIs or identifiers generated at the alternate EES which may correspond (e.g., map to) pre-existing resources at the active EES and may be used by the consumer node to retrieve migrated resources. Required procedures information may be information related to existing procedures that the alternate EES requires the consumer node to perform before using the alternate EES, for example, the alternate EES may indicate to an EEC to perform an EEC registration update with the alternate EES or the alternate EES may indicate to an EAS to perform an EAS registration update with the alternate EES so the alternate EES may confirm that the server switch was successful and may also allow the alternate EES to acquire the endpoint information (e.g., IP address) of the consumer node if needed.

Referring to 7, upon receiving the server switch response, the consumer nodes (e.g., EEC, EAS) may update its bindings with the active EES. To update bindings, a consumer node may require any of: (1) replacing endpoint information of the active EES with endpoint information of the alternate EES, (2) performing service provisioning to acquire connectivity information about the alternate EES, (3) creating a PDU session to the EDN associated with the alternate EES, and (4) replacing URIs or identifiers associated with resources that were originally created with the active EES using the mapping information provided in the server switch notification.

Referring to 8, if the server switch response received at step 6 included an indication of a required procedure, the consumer nodes (e.g., EEC, EAS) may perform the required procedure with the alternate EES. For example, the alternate EES may indicate that the EEC or EAS registration update is required after updating bindings. Such required procedure may allow the alternate EES to confirm that the migration of the consumer node completed properly.

In various embodiments, the replacement of an ECS active server may be unplanned, for example an active server may lose power or connectivity and become unreachable. Server switch may be performed in a “break-before-make” manner, allowing consumer nodes (e.g., EEC, EES) migration to an alternate ECS server after the active server becomes unavailable.

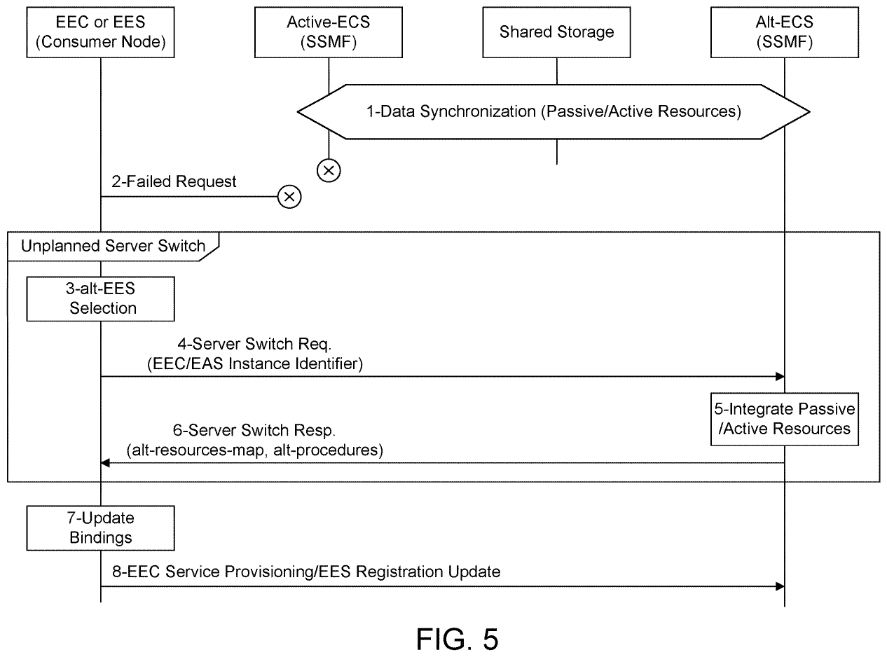

FIG. 5 shows an example of a procedure for consumer nodes, active ECS and alternate ECS re-configuration in a “break-before-make” scenario.

Prior to BBM procedure, the consumer nodes (e.g., EEC, EAS) may have discovered the active ECS, may have been configured with an ECS server set, and may have subscribed to ECS server set events.

To support break-before-make, BBM, server switch using an ECS server set, a synchronization methodology may be pre-established between ECSs of the server set. The synchronization methodology may be centralized and based on a shared storage or distributed and based on a messaging scheme.

Referring to 1, the active ECS and alternate ECSs, member of the same ECS server set, may publish data about the passive and active resources in a centralized or distributed manner.

Referring to 2, the consumer node (e.g., EEC or EES) may perform a request with the active ECS and the request may fail indicating that the active ECS is unexpectedly unavailable. For example, a consumer node may consider that a request timeout failure indicates that a server is unavailable while a “forbidden” response indicates another issue. Alternatively, the consumer node(s) may implement a watchdog mechanism to allow to detecting active server unavailability in a consistent manner. For example, the consumer node may send a keepalive request to the active server on a periodic basis to perform a timely detection of unavailability.

Referring to 3, the consumer node may perform a selection of an alternate ECS based on the server set configuration that was provisioned. The selection may be based on KPIs that are similar to those of the active ECS or may be based on other validity conditions such as any of ECSP, service area, time, and alternate server priority.

Referring to 4, the consumer node may send a server switch request to the selected alternate ECS, providing in the server switch request an EEC or EES instance identifier. The EEC or EES identifier may be used by the alternate ECS to identify passive and active resources associated with the consumer node. Data about the passive and active resources may be available in a shared storage or at the alternate ECS dependent on a centralized or distributed synchronization mechanism is used.

Referring to 5, upon receiving the server switch request from the consumer node, the alternate ECS may integrate the active ECS passive and active resources associated with the consumer node and identified using the EEC or EES instance identifier. Integrating received resources may require any of: (1) storing the data related to the identified resources in the alternate ECS, (2) validating that the identified resources are compatible with the alternate ECS capabilities, (3) regenerating resource identifiers or URIs at the alternate ECS for the identified resources, (4) initiating event detection at the alternate ECS for the subscription resources, and (5) requesting periodic events from the 5GS at the alternate ECS.

Referring to 6, upon completing integration of the passive and active resources identified using the server switch request, the alternate ECS may send a server switch response to the consumer node which may indicate that the resource integration is completed. The server switch response may further contain resource mapping information related to newly integrated resources at the alternate ECS and how these integrated resources map to the resources originally found at the active ECS. The server switch response may further contain indication of required procedures with the alternate ECS which may indicate to the alternate ECS that the server switch completed successfully at the consumer node. For example, resource mapping information may include newly generated URIs or identifiers generated at the alternate ECS may correspond (e.g., map to) pre-existing resources at the active ECS and may be used by the consumer node to retrieve migrated resources. Required procedures information may be information related to existing procedures that the alternate ECS requires the consumer node to perform before using the alternate ECS. For example, the alternate ECS may indicate to an EEC to perform a service provisioning request with the alternate ECS or the alternate ECS may indicate to an EES to perform an EES registration update with the alternate ECS so the alternate ECS may confirm that the server switch was successful and may also allow the alternate ECS to acquire the endpoint information (e.g., IP address) of the consumer node if needed.

Referring to 7, upon receiving the server switch response, the consumer nodes (e.g., EEC, EES) may update its bindings with the active ECS. To update bindings, a consumer node may require any of (1) replacing endpoint information of the active ECS with endpoint information of the alternate ECS, (2) performing service provisioning to acquire connectivity information about the alternate ECS, (3) creating a PDU session to the EDN associated with the alternate ECS, and (4) replacing URIs or identifiers associated with resources that were originally created with the active ECS using the mapping information provided in the server switch notification.

Referring to 8, if the server switch response received in step 6 included an indication of a required procedure, the consumer nodes (e.g., EEC, EES) may perform the required procedure with the alternate ECS. For example, the alternate ECS may indicate that the EEC shall perform service provisioning with the alternate ECS or that the EES shall perform EES registration update after updating bindings. Such required procedure may allow the alternate ECS to confirm that the migration of the consumer node completed properly.

In various embodiments, the replacement of an EES active server may be planned, triggered and managed to minimize service unavailability. Server switch may be performed in a “make-before-break” manner, allowing consumer nodes (e.g., EAS, EEC) migration to an alternate EES before the active EES becomes unavailable.

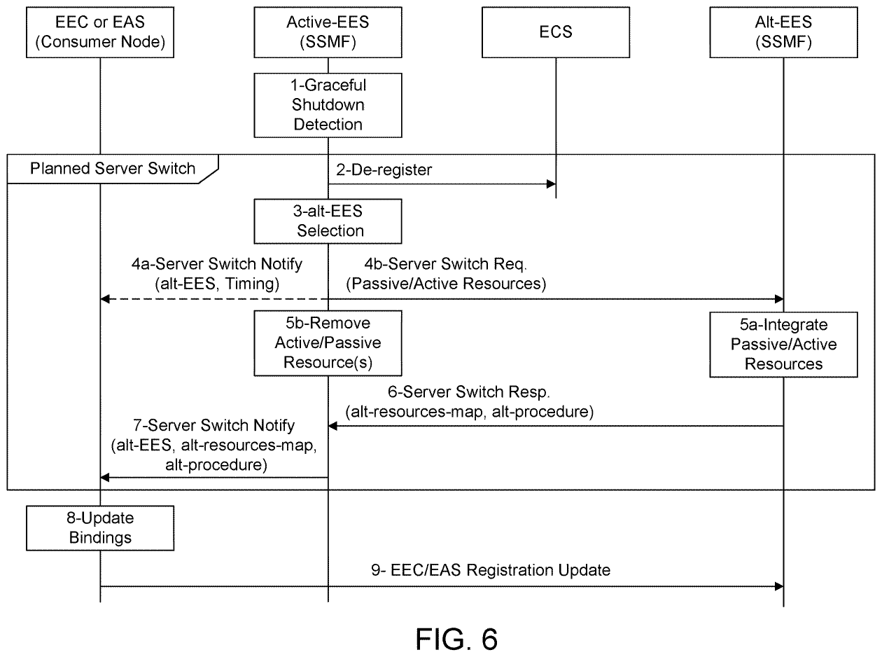

FIG. 6 shows an example of a procedure for consumer node, active EES and alternate EES re-configuration in a “make-before-break”, MBB, scenario.

Prior to MBB procedure, the consumer nodes (e.g., EEC, EAS) may have discovered the active EES, may have been configured with an EES server set, and may have subscribed to EES server set events.

Referring to 1, an active EES implementing an SSMF may detect that it will become unavailable. For example, the SSMF may detect that an EES is configured to shutdown in order to perform maintenance of the EES. For example, the SSMF may be subscribed to a NWDAF network function in the 5G system, the SSMF may detect unavailability when it is informed that the connectivity to the SSMF is expected to be down. The active EES may detect that it is configured to migrate the consumer nodes to an alternate EES before becoming unavailable (e.g., if the active EES implements an SSMF and is configured with a server set).

Referring to 2, the active EES may deregister from the ECS where it originally registered, for example to make the EES undiscoverable through the service provisioning procedure with the ECS.

Referring to 3, the active EES may perform a selection of an alternate EES based on the server set configuration. The selection may be based on KPIs that are similar to those of the active EES or may be based on other validity conditions such as any of ECSP, service area, time, and alternate server priority.

Referring to 4, the active EES may send a server switch notification (4a) to the consumer nodes (e.g., EEC, EAS) to provide an early indication that the server switch is initiated. The server switch notification may include an identifier of the selected alternate server. The server switch may further include timing information providing an expected duration for the server switch operation before the server switch is available. The consumer node may use the information included in the early notification to prepare for the server migration. For example, the consumer node may: (1) stop contacting the active server, (2) obtain connectivity information about the alternate server, (3) start a timer before contacting the alternate server.

The active EES may send a server switch request to the selected alternate EES (4b), providing in the server switch request the data related to passive and active resources present at the active EES.

Referring to 5, upon receiving the server switch request from the active EES, the alternate EES may integrate the active EES passive and active resources (5a). Integrating received resources may require any of: (1) storing the data related to the received resources in the alternate EES, (2) validating that the received resources are compatible with the alternate EES capabilities, (3) regenerating resource identifiers or URIs at the alternate EES for the received resources, (4) initiating event detection at the alternate EES for the subscription resources, (5) initiating ACR detections at the alternate EES, and (6) requesting periodic events from the 5GS at the alternate EES.

After sending the server switch request to the alternate EES, the active EES may remove all active and passive resources (5b) that were sent to the alternate EES. Removing resources may require deleting data related to the resources in the active EES, or terminating any processing such as event detection, or cancelling periodic events requested from the 5GS.

Referring to 6, upon completing integration of the passive and active resources received in the server switch request, the alternate EES may send a server switch response to the active EES which may (1) indicate that the resource integration is completed, (2) contain resource mapping information, and (3) contain indication of required procedures that consumer nodes shall perform with the alternate EES.

Referring to 7, the active EES may send a server switch notification to all consumer nodes (e.g., EEC, EAS) that have subscribed to receive such event. The server switch notification may contain information related to the alternate EES, for example the IP address/URL/FQDN, the EES identifier, the EES profile, information about the resource mapping at the alternate server, information about required procedures that the consumer nodes shall perform with the alternate server. The active EES may provide to each individual subscribed consumer node only a subset of the resource mapping at the alternate server that correspond to resources that were related to the specific consumer node.

Referring to 8, upon receiving the server switch notification, the consumer nodes (e.g., EEC, EAS) may update its bindings with the active EES. To update bindings, a consumer node may require any of: (1) replacing endpoint information of the active EES with endpoint information of the alternate EES, (2) performing service provisioning to acquire connectivity information about the alternate EES, (3) creating a PDU session to the EDN associated with the alternate EES, (4) replacing URIs or identifiers associated with resources that were originally created with the active EES using the mapping information provided in the server switch notification.

Referring to 9, if the server switch notification received at step 7 included an indication of a required procedure, the consumer nodes (e.g., EEC, EAS) may perform the required procedure with the alternate EES. For example, the alternate EES may indicate that the EEC/EAS registration update is required after updating bindings. Such required procedure may allow the alternate EES to confirm that the migration of the consumer node completed properly.

The MBB procedure shown on FIG. 6 does not rely on centralized or distributed synchronization between the servers of the server set.

It may be appreciated that the EES make-before-break, MBB, procedure may rely on synchronization mechanisms with the following change on FIG. 6: At step 4, the server switch request sent from the active EES to the alternate EES may contain consumer node (e.g., EEC, EAS) instance identifier(s) of all the consumer nodes related to the active EES and for which the active EES has selected the alternate EES. At step 5a, the alt-EES may retrieve from the shared storage the passive and active resources data associated to the consumer node instance identifier. This is similar to step 4 and step 5 of FIG. 4

In various embodiments, the replacement of an ECS active server may be planned, triggered and managed to minimize service unavailability. Server switch may be performed in a “make-before-break”, MBB, manner, allowing consumer nodes (e.g., EAS, EES) migration to an alternate ECS before the active ECS becomes unavailable.

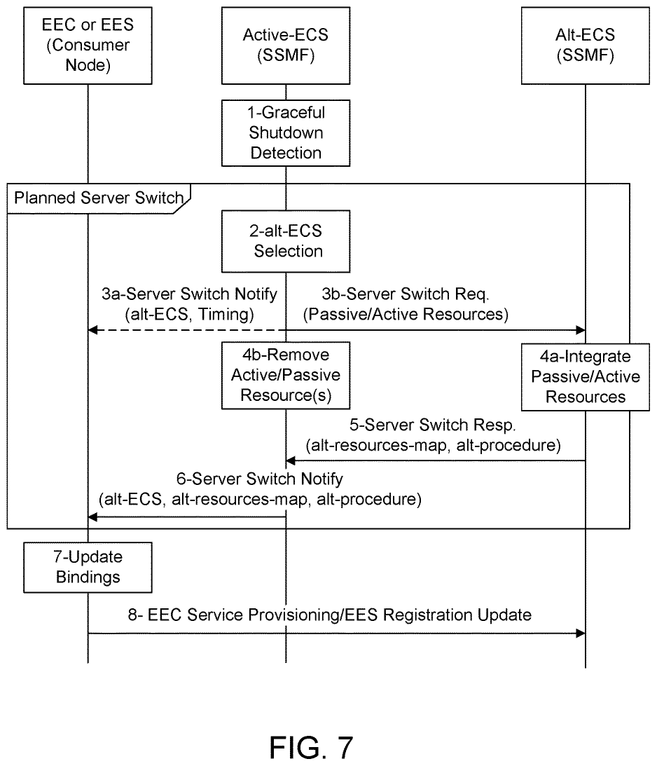

FIG. 7 shows an example of a procedure for consumer node, active ECS and alternate ECS re-configuration in a MBB scenario.

Prior to the MBB procedure, the consumer nodes (e.g., EEC, EES) may have discovered the active ECS, may have been configured with an ECS server set, and may have subscribed to ECS server set events.

Referring to 1, an active ECS implementing an SSMF may detect that it will become unavailable (e.g., if an ECS is configured to shutdown in order to perform maintenance of the ECS). The active ECS may detect that it is configured to migrate the consumer nodes to an alternate ECS before becoming unavailable, for example if the active ECS implements an SSMF and is configured with a server set.

Referring to 2, the active ECS may perform a selection of an alternate ECS based on the server set configuration. The selection may be based on KPIs that are similar to those of the active ECS or may be based on other validity conditions such as any of ECSP, service area, time, and alternate server priority.

Referring to 3, the active ECS may send a server switch notification (3a) to the consumer nodes (e.g., EEC, EES) to provide an early indication that the server switch is initiated. The server switch notification may include an identifier of the selected alternate server. The server switch notification may further include timing information providing an expected duration for the server switch operation before the server switch is available. The consumer node may use the information included in the early notification to prepare for the server migration. For example, the consumer node may: (1) stop contacting the active server, (2) obtain connectivity information about the alternate server, and (3) start a timer before contacting the alternate server.

The active ECS may send a server switch request to the selected alternate ECS (3b), providing in the server switch request the data related to passive and active resources present at the active EES.

Referring to 4, upon receiving the server switch request from the active ECS, the alternate ECS may integrate the active ECS passive and active resources (4a). Integrating received resources may require any of (1) storing the data related to the received resources in the alternate ECS, (2) validating that the received resources are compatible with the alternate ECS capabilities, (3) regenerating resource identifiers or URIs at the alternate ECS for the received resources, (4) initiating event detection at the alternate ECS for the subscription resources, and (5) requesting periodic events from the 5GS at the alternate ECS.

After sending the server switch request to the alternate ECS, the active ECS may remove all active and passive resources (4b) that were sent to the alternate ECS. Removing resources may require deleting data related to the resources in the active ECS, or terminating any processing such as event detection, or cancelling periodic events requested from the 5GS.

Referring to 5, upon completing integration of the passive and active resources received in the server switch request, the alternate ECS may send a server switch response to the active ECS which may indicate that the resource integration is completed. The server switch response may contain resource mapping information, and may contain indication of required procedures with the alternate ECS. Details about the server switch response are the same as in step 6 of FIG. 5.

Referring to 6, the active ECS may send a server switch notification to all consumer nodes (e.g., EEC, EES) that have subscribed to receive such event. The server switch notification may contain information related to the alternate ECS, for example the IP address/URL/FQDN, the ECS identifier, the ECS profile, information about the resource mapping at the alternate server, information about required procedures that the consumer node shall perform with the alternate server. The active ECS may provide to each individual subscribed consumer node only a subset of the resource mapping at the alternate server that correspond to resources that were related to the specific consumer node.

Referring to 7, upon receiving the server switch notification, the consumer nodes (e.g., EEC, EES) may update its bindings with the active ECS. To update bindings, a consumer node may require replacing endpoint information of the active ECS with endpoint information of the alternate ECS. The consumer node may require performing service provisioning to acquire connectivity information about the alternate ECS. The consumer node may require creating a PDU session to the EDN associated with the alternate ECS. The consumer node may require replacing URIs or identifiers associated with resources that were originally created with the active ECS using the mapping information provided in the server switch notification.

Referring to 8, if the server switch notification received in step 6 included an indication of a required procedure, the consumer nodes (e.g., EEC, EES) may perform the required procedure with the alternate ECS. For example, the alternate ECS may indicate that the EEC shall perform a service provisioning with the alternate ECS and may indicate that the EES shall perform an EES registration update with the alternate ECS after updating bindings. Such required procedure may allow the alternate ECS to confirm that the migration of the consumer node completed properly.

The procedure shown on FIG. 7 does not rely on centralized or distributed synchronization between the servers of the server set.

It may be appreciated that the ECS make-before-break procedure may rely on synchronization mechanisms with the following change on FIG. 7: in step 3, the server switch request sent from the active ECS to the alternate ECS may contain consumer node (e.g., EEC , EES) instance identifier(s) of all the consumer nodes related to the active ECS and for which the active ECS has selected the alternate ECS. At step 4a, the alt-EES may retrieve from the shared storage the passive and active resources data associated to the consumer node instance identifier. This is similar to step 4 and step 5 of FIG. 4.

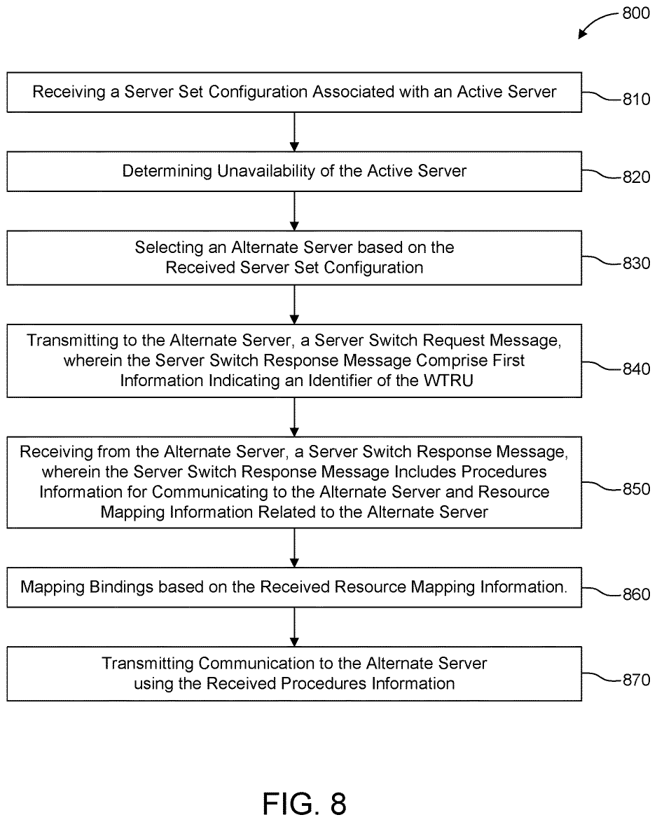

FIG. 8 is a flow chart illustrating an example of a method 800, performed by a consumer node for relocating a server in a break-before-make manner. The consumer node may be a WTRU, an edge enabler client, an edge application server, or an edge enabler server.

Referring to FIG. 8, the method 800 may comprise a first step, wherein the consumer node (e.g., WTRU) may receive 810 a server set configuration associated with an active server. Prior to receive the server set configuration, the consumer node (e.g., WTRU) may discover the active server, wherein the active server may have SSMF capability. More particularly, the SSMF capability may include functionality for managing server set configuration and switching from the active server to the alternate server.

The method 800, may comprise a step wherein the consumer node (e.g., WTRU) may determine 820 (e.g., detect) unavailability of the active server. For example, the unavailability may be determined due to expiration of a timeout associated with the communication between the active server and the consumer node or due to a timeout failure of communication with the active server. In another example of determining unavailability of the active server, the method may comprise a step of receiving a message from the active server indicating unavailability of the active sever coming soon.

The method 800, may comprise a step wherein the consumer node (e.g., WTRU) may select 830 an alternate server based on the received server set configuration. The method 800 may comprise a step wherein the consumer node (e.g., WTRU) may transmit 840, to the alternate server, a server switch request message, wherein the server switch request message may comprise first information indicating an identifier of the consumer node (e.g., WTRU).

The method 800, may comprise a step, wherein the consumer node (e.g., WTRU) may receive 850, from the alternate server, a server switch response message, wherein the server switch response message may include procedures information for communicating to the alternate server and resource mapping information related to the alternate server. The procedures information may, comprise procedures for confirming server switch successful, wherein the procedures for confirming server switch successful may comprise a registration updated procedure with the alternate server. The server switch response message may comprise second information indicating integration of active server passive and active resources associated with the WTRU completed, and wherein the resource mapping information are related to the integrated resources. The resource mapping information may include uniform resource identifiers URIs or identifiers corresponding to resources at the active server.

The method 800, may comprise a step of mapping 860 bindings based on the received resource mapping information. The method 800 may comprise a step of replacing the bindings to the active server with bindings to the alternate server, wherein replacing the bindings may include endpoint information of the active server with endpoint information of the alternate server.

The method, 800 may comprise a step, wherein the consumer node (e.g., WTRU) may transmit 870 communication to the alternate server based on the received procedures information.

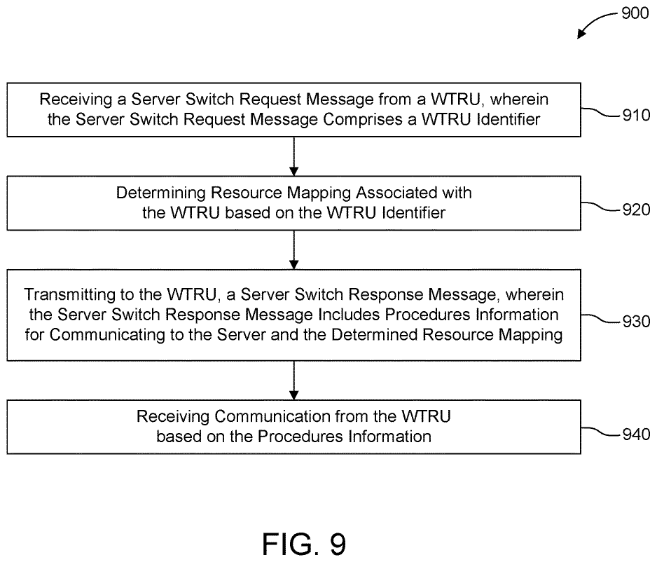

FIG. 9 is a flow chart illustrating an example of a method 900 performs by an alternate server for relocating an active server. The alternate server may be an edge enable server or an edge configuration server implementing functionalities for managing server set configuration and switching from an active server to an alternate server.

Referring to FIG. 9, the method 900, may comprise a step wherein the (e.g., alternate) server may receive 910 a server switch request message from a wireless transmit/receive unit, WTRU, wherein the server switch request message may comprise a WTRU identifier. The server switch message may further comprise passive resource information and/or active resource information. The method 900 may comprise a step of determining 920 resource mapping associated with the WTRU based on the WTRU identifier. The method 900, may comprise a step, wherein the (e.g., alternate) server may identify passive and active resources associated with the WTRU based on the WTRU identifier. The (e.g., alternate) server may integrate the identified passive and active resources associated with the WTRU, wherein integrating the identified passive and active resources may include any of storing resources, validating resources, regenerating URIs and identifiers of resources, initiating event detection associated with resources and requesting periodic events associated with the resources (e.g., from a 5G system).

The method 900, may comprise a step wherein the (e.g., alternate) server may transmit 930, to the WTRU, a server switch response message, wherein the server switch response message may include procedures for communicating to the server and the determined resource mapping. The method 900, may comprise a step, wherein the (e.g., alternate) server may receive 940 communication from the WTRU based on the procedures information. More particularly, under condition that (e.g., alternate) server procedures information are provided in the server switch response message, the (e.g., alternate) server may wait for messages related to the (e.g., alternate) server procedures. The WTRU may be a consumer node.

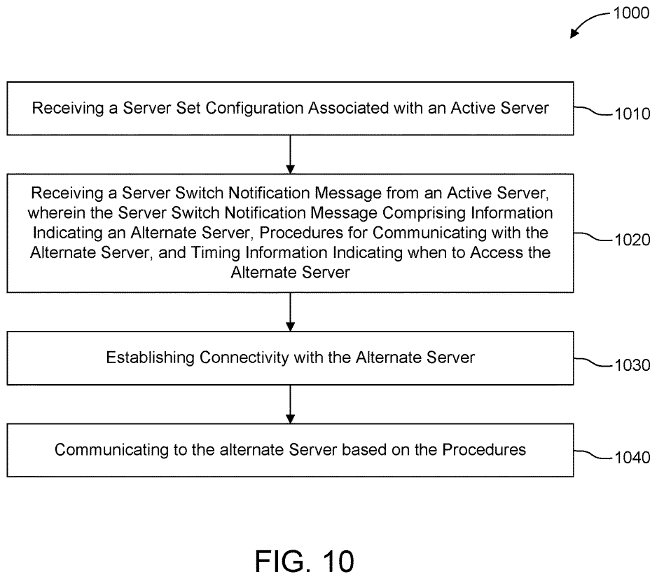

FIG. 10 is a flow chart illustrating an example of a method 1000, performed by a consumer node (e.g., WTRU) for relocating a server in a make-before-break manner. The consumer node may be a WTRU, an edge enabler client, an edge application server, or an edge enabler server.

Referring to FIG. 10, the method 1000 may comprise a step wherein the consumer node (e.g., WTRU) may receive 1010 a server set configuration associated with an active server. Prior to receive the server set configuration, the consumer node may discover the active server, wherein the active server may comprise SSMF capabilities. More particularly, the SSMF capabilities may comprise functionalities for managing server set configuration and switching from the active server to the alternate server.

The method 1000, may comprise a step wherein the consumer node (e.g., WTRU) may receive 1020 a server switch notification message from an active server, wherein the server switch notification message comprising information indicating an alternate server, procedures for communicating with the alternate server, and timing information indicating when to access the alternate server. The notification message may further comprise an identifier of the alternate server, an alternate server endpoint, mappings of active server resources associated with the alternate server. The consumer node (e.g., WTRU) may set up a timer indicating when to access to the alternate server, based on the timing information.

The method 1000 may comprise a step wherein the consumer node (e.g., WTRU) may establish 1030 connectivity with the alternate server (e.g., of an edge data network). The method 1000 may comprise a step wherein the consumer node (e.g., WTRU) may communicate 1040 with the alternate server based on the procedures for communicating.

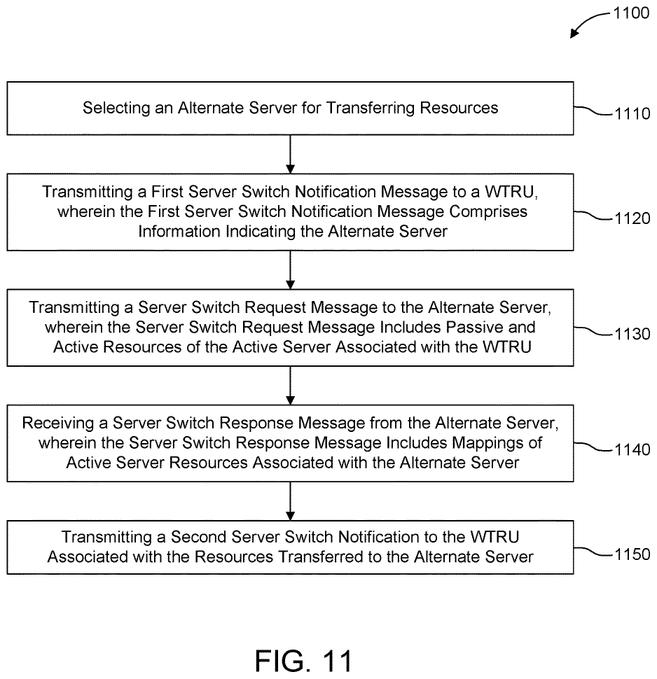

FIG. 11 is a flow chart illustrating an example of a method 1100 performed by an active server for relocating the active server in a make-before-break manner. The active server may be an edge enabler server or an edge configuration server comprising functionalities for managing server set configuration and switching from the active server to the alternate server.

Referring to FIG. 11, the method 1100 may comprise a step wherein the active server may select 1110 an alternate server for transferring resources. The method 1100 may comprise a step wherein the active server may transmit 1120 a first server switch notification message to a WTRU, wherein the first server switch notification message may comprise information indicating the alternate server. The WTRU may be a consumer node. The first server switch notification message may further comprise timing information indicating when to access the alternate server. The method 1100 may comprise a step wherein the active server may transmit 1130 a server switch request message to the alternate server, wherein the server switch request message includes passive and active resources of the active server associated with the WTRU. The method may comprise a step wherein the active server may receive 1140 a server switch response message from the alternate server, wherein the server switch response message may include mappings of active server resources associated with the alternate server. The server switch response message from the alternate server may further include a list of procedures that the WTRU shall perform with the alternate server. The method 1100 may comprise a step wherein the active server may transmit 1150 a second server switch notification to the WTRU associated with the resources transferred to the alternate server.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method implemented in a wireless transmit/receive unit, WTRU, the method comprising:
receiving a server set configuration associated with an active server;
determining unavailability of the active server;
selecting an alternate server based on the received server set configuration;
transmitting, to the alternate server, a server switch request message, wherein the server switch request message comprises first information indicating an identifier of the WTRU;
receiving, from the alternate server, a server switch response message, wherein the server switch response message comprises procedures information for communicating to the alternate server and resource mapping information related to the alternate server;
mapping bindings based on the received resource mapping information; and
transmitting communication to the alternate server using the received procedures information.

2. The method of claim 1, wherein the procedures information comprises procedures for confirming server switch success.

3. The method of claim 2, wherein the procedures for confirming server switch success comprise a registration update procedure with the alternate server.

4. The method of claim 1, wherein the server switch response message comprises second information indicating integration of active server passive and active resources associated with the WTRU is completed, and wherein the resource mapping information are is related to the integrated resources.

5. The method of claim 1, wherein the resource mapping information comprises uniform resource identifiers, URIs, or identifiers corresponding to resources at the active server.

6. The method of claim 1, comprising, prior to receiving the server set configuration:
discovering the active server, wherein the active server comprises functionalities for managing server set configuration and switching from the active server to the alternate server.

7. The method of claim 1, comprising replacing bindings to the active server with bindings to the alternate server.

8. The method of claim 7, wherein replacing bindings comprises replacing endpoint information of the active server with endpoint information of the alternate server.

9. The method of claim 1, wherein the WTRU is a consumer node.

10. The method of claim 1, wherein determining unavailability of the active server is based on a timeout failure of communication with the active server.

11. (canceled)

12. A wireless transmit/receive unit, WTRU, comprising any of a memory and a processor, configured to:
receive a server set configuration associated with an active server;
determine unavailability of the active server;
select an alternate server based on the received server set configuration;
transmit, to the alternate server, a server switch request message, wherein the server switch request message comprises first information indicating an identifier of the WTRU;
receive, from the alternate server, a server switch response message, wherein the server switch response message comprises procedures information for communicating to the alternate server and resource mapping information related to the alternate server;
map bindings based on the received resource mapping information; and
transmit communication to the alternate server based on the received procedures information.

13. The WTRU of claim 12, wherein the procedures information comprises procedures for confirming server switch success.

14. The WTRU of claim 13, wherein the procedures for confirming server switch successful comprises a registration update procedure with the alternate server.

15. The WTRU of claim 12, wherein the server switch response message comprises second information indicating integration of active server passive and active resources associated with the WTRU is completed, and wherein the resource mapping information are is related to the integrated resources.

16. The WTRU of claim 12, wherein the resource mapping information comprises uniform resource identifiers, URIs, or identifiers corresponding to resources at the active server.

17. The WTRU of claim 12, configured to, prior to receiving the server set configuration:
discover the active server, wherein the active server comprises functionalities for managing server set configuration and switching from the active server to the alternate server.

18. The WTRU of claim 12, configured to replace bindings to the active server with bindings to the alternate server.

19. The WTRU of claim 18, wherein being configured to replace bindings comprises being configured to replace endpoint information of the active server with endpoint information of the alternate server.

20. The WTRU of claim 12, wherein the WTRU is a consumer node.

21. The WTRU of claim 12, wherein being configured to determine unavailability of the active server comprises being configured to determine unavailability of the active server based on a timeout failure of communication with the active server.

22-27. (canceled)
